(19) United States
(12) Patent Application Publication
(10) Pub. No.: US 2026/0056888 A1
(43) Pub. Date: Feb. 26, 2026

(54) VIRTUAL TO PHYSICAL PARTIAL TRANSLATION CACHE FOR ACCELERATING VIRTUALIZED PAGE TABLE WALKS

(71) Applicant: Ampere Computing LLC, Santa Clara, CA (US)

(72) Inventors: Benjamin Crawford CHAFFIN, Portland, OR (US); George LEMING, Lake Oswego, OR (US); Bret TOLL, Hillsboro, OR (US)

(21) Appl. No.: 18/812,901

(22) Filed: Aug. 22, 2024

(51) Int. Cl. G06F 12/1009; G06F 12/1045

(52) U.S. Cl. CPC G06F 12/1009; G06F 12/1045

(57) ABSTRACT

Disclosed are techniques for operating a memory management unit (MMU). In an aspect, the MMU receives a virtual address for a partial translation cache, wherein the partial translation cache stores translations from virtual addresses to physical addresses, reads a physical address corresponding to the virtual address from one or more page table entries of one or more levels of the partial translation cache, and accesses a physical memory location corresponding to the physical address.

### BACKGROUND OF THE DISCLOSURE

### 1. Field of the Disclosure

Aspects of the disclosure relate generally to partial translation caches for virtualized page tables.

### 2. Description of the Related Art

Second level address translation (SLAT), also referred to as “nested paging,” is a hardware-assisted virtualization technology that makes it possible to avoid the overhead associated with software-managed shadow page tables. In greater detail, a hypervisor (also referred to as a “virtual machine monitor” or “virtualizer”) creates and runs one or more virtual machines. A computer on which a hypervisor runs one or more virtual machines is referred to as a “host machine” and each virtual machine is referred to as a “guest machine.” The hypervisor presents the guest operating system(s) with a virtual operating platform, including virtual memory, and manages the execution of the guest operating system(s).

When a guest system uses virtual addresses and an instruction requests access to memory, the host processor translates the virtual memory address to a physical memory address using a page table or translation look-aside buffer (TLB). When running a virtual system, virtual memory of the host system serves as physical memory for the guest system. As such, to translate a virtual address (VA) in the guest system to a physical address (PA) in the host system, the address translation needs to be performed twice-once inside the guest system (translating from the VA to an intermediate physical address (IPA) using one or more virtual machine page tables), and once inside the host system (translating from the IPA to the PA using one or more hypervisor page tables). The former translation is referred to as a first stage translation and the latter translation is referred to as a second stage translation.

A hit in a first stage partial translation cache still needs to execute a second stage translation. This would result in performing, at best, one additional page table entry read (in the case of a second stage partial translation cache hit) and, at worst, four reads (in the case of a cache miss). These additional reads result in associated latency and power costs.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a memory management unit (MMU) includes receiving a virtual address for a partial translation cache, wherein the partial translation cache stores translations from virtual addresses to physical addresses; reading a physical address corresponding to the virtual address from one or more page table entries of one or more levels of the partial translation cache; and accessing a physical memory location corresponding to the physical address.

In an aspect, an apparatus includes one or more memories; and one or more processors; and a memory management unit (MMU) coupled to the one or more processors and the one or more memories, the MMU configured to: receive a virtual address for a partial translation cache, wherein the partial translation cache stores translations from virtual addresses to physical addresses; read a physical address corresponding to the virtual address from one or more page table entries of one or more levels of the partial translation cache; and access a physical memory location in the one or more memories corresponding to the physical address.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example system according to aspects of the disclosure.

FIG. 2 illustrates an example translation table, according to aspects of the disclosure.

FIG. 3 illustrates the stages involved in an example address translation, according to aspects of the disclosure.

FIG. 4 illustrates an example translation look-aside buffer (TLB) entry, according to aspects of the disclosure.

FIG. 5A is a block diagram illustrating a two-stage translation from a virtual address (VA) to a physical address (PA), according to aspects of the disclosure.

FIG. 5B illustrates an example two-stage, or nested, translation flow, according to aspects of the disclosure.

FIG. 6 is a diagram illustrating an example logic flow of a page table walk, according to aspects of the disclosure.

FIG. 7 is a diagram illustrating a fully virtualized page table walk of a Stage-1 partial translation cache that stores the full virtual address to physical address translations of the non-leaf levels of the page table, according to aspects of the disclosure.

FIG. 8 is a diagram illustrating an example logic flow within a partial translation cache, according to aspects of the disclosure.

FIG. 9 illustrates an example method for operating a memory management unit (MMU), according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to”perform the described action.

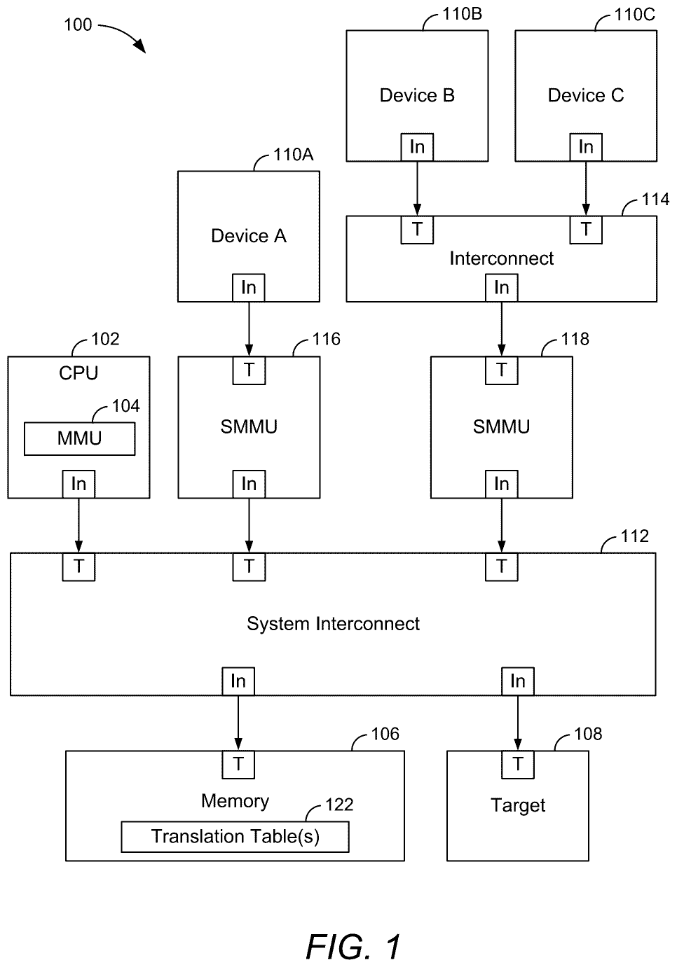

FIG. 1 illustrates an example system 100 according to aspects of the disclosure. The system 100 may be incorporated into any electronic device. The components of the system 100 include one or more central processors, such as central processing unit (CPU) 102, one or more interconnects (or buses), such as interconnects 112 and 114, one or more peripheral devices (or upstream devices), such as devices 110A, 110B, and 110C, and one or more target devices, such as memory 106 and target 108. The system 100 further includes a memory management unit (MMU) 104 coupled to the CPU 102 and system memory management units (SMMUs) 116 and 118 coupled to the system interconnect 112. As will be appreciated, although FIG. 1 illustrates the MMU 104 as being part of the CPU 402, the MMU 104 may be externally coupled to the CPU 102.

Devices 110A-C may include any other component of the electronic device that is “upstream” from the perspective of the MMU 104 and/or the SMMUs 116 and 118. That is, devices 110A-C may be any component of the electronic device embodying system 100 from which the MMU 104/SMMUs 116 and 118 receive commands/instructions, such as a graphics processing unit (GPU), a digital signal processor (DSP), a peripheral component interconnect express (PCIe) root complex, a universal serial bus (USB) interface, a local area network (LAN) interface, a universal asynchronous receiver/transmitter (UART), etc. Target 108 may be any “downstream” component of the electronic device embodying the system 100 that receives output from the MMU 104/SMMUs 116 and 118. For example, target 108 may include system registers, memory mapped input/output, etc.

An SMMU provides address translation services for upstream device traffic in much the same way that an MMU (e.g., MMU 104) translates addresses for processor memory accesses. Referring to FIG. 1, each component includes a “T” and/or an “In,” indicating that it is a “target” to the upstream device and/or an “initiator” to the downstream device. As illustrated in FIG. 1, SMMUs 116 and 118 reside between a system device's initiator port and the system targets. For example, as illustrated in FIG. 1, SMMUs 116 and 118 reside between the initiator ports of devices 110A-C and the system target, e.g., system interconnect 112.

A single SMMU 116/118 may serve a single peripheral device or multiple peripheral devices, depending on system topology, throughput requirements, etc. FIG. 1 illustrates an example topology in which device 110A has a dedicated SMMU 116 while devices 110B and 110C share SMMU 118. Note that although the arrows shown in FIG. 1 illustrate unidirectional communication between the illustrated components, this is simply to show example communication through the MMU 104 and SMMUs 116 and 118. As is known in the art, the communication between the components in the system 100 may be bidirectional.

The main functions of an MMU, such as MMU 104 and SMMUs 116 and 118, include address translation, memory protection, and attribute control. Address translation is the translation of an input address to an output address. Translation information is stored in translation tables 122 (including partial translation caches and translation look-aside buffers (TLBs)) that the MMU references to perform address translation. There are two main benefits of address translation. First, it allows devices to address a large physical address space. For example, a 32-bit device (i.e., an electronic device capable of referencing 2³² address locations) can have its addresses translated by an MMU such that it may reference a larger address space (such as a 36-bit address space or a 40-bit address space). Second, it allows devices to have a contiguous view of buffers allocated in memory, despite the fact that memory buffers are typically fragmented, physically discontiguous, and scattered across the physical memory space.

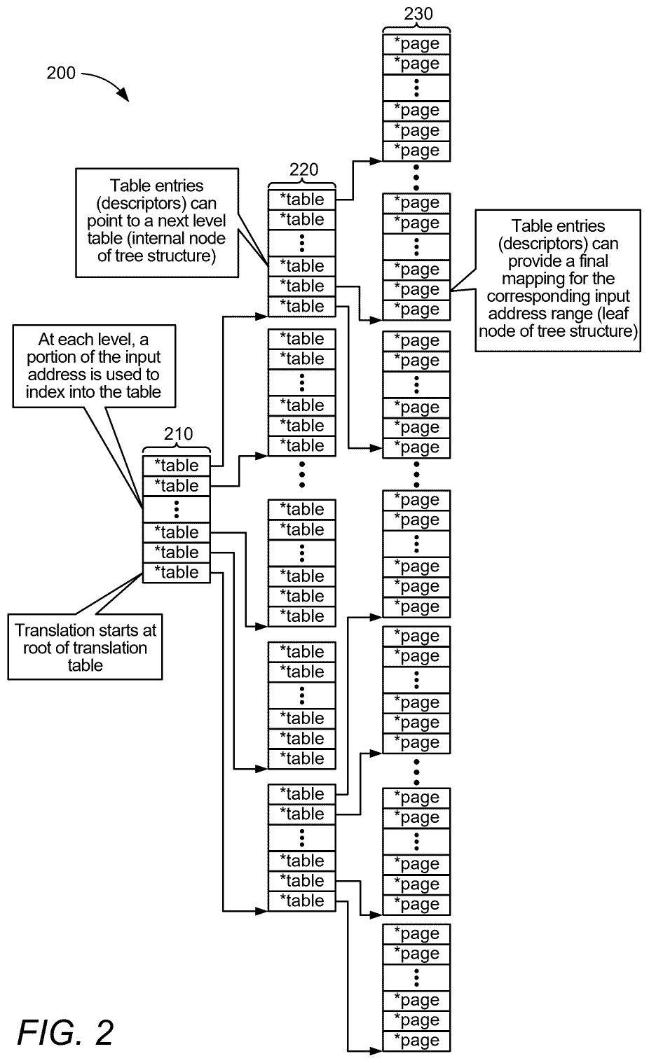

FIG. 2 illustrates an example translation table 200 according to an aspect of the disclosure. A translation table, such as translation table 200, contains the information needed to perform address translation for a range of input addresses. It consists of a top-level (or “root”) table 210, one or more mid-level (or “intermediate”) sets of sub-tables 220, and a set of bottom-level (or “leaf”) tables 230 arranged in a multi-level “tree” structure. Note, for simplicity, FIG. 2 illustrates a single mid-level set of sub-tables 220, but there may be any number of mid-levels. The number of levels may be specified by the particular architecture. For example, the ARM® architecture specifies the maximum number of levels for a given translation regime.

The term “translation table entry” refers generically to any entry in a translation table. A translation table is also referred to as a “page table,” and thus, the term “page table entry” may be used interchangeably with the term “translation table entry.” There are two types of page table entries, intermediate page table entries and leaf page table entries. Within a given sub-table (e.g., sub-table 220 in FIG. 2), page table entries do not have to be of the same type (i.e., intermediate or leaf entries). For example, one entry may be a “block/page” descriptor (indicating that the entry is a leaf entry and thus the final mapping), and the adjacent entry could be an intermediate “table” descriptor, which points to the next level table (e.g., one of sub-tables 220 in FIG. 2). In other words, to perform translation, the three lookups illustrated in FIG. 2 (e.g., 210, 220, and 230) are not always required. Some table walks may terminate (i.e., encounter a block/page descriptor) after two levels (e.g., at 220), or even after one level (e.g., at 210). In these cases, the block/page descriptors will map to a larger range of virtual address space.

Each table 210-230 is indexed with a sub-segment of the input address. Each table 210-230 consists of translation table descriptors (that is, may contain “leaf” nodes/entries). There are three base types of descriptors: 1) an invalid descriptor, which indicates a mapping for the corresponding virtual address does not exist, 2) table descriptors, which contain a base address to the next level sub-table and may contain translation information (such as access permission) that is relevant to all sub-sequent descriptors encountered during the walk, and 3) block descriptors, which contain a base output address that is used to compute the final output address and attributes/permissions relating to block descriptors.

The process of traversing the translation table to perform address translation is known as a “translation table walk.” A translation table walk is accomplished by using a sub-segment of an input address to index into the translation sub-table, and finding the next address until a block descriptor is encountered. A translation table walk consists of one or more “steps.” Each “step” of a translation table walk involves 1) an access to the translation table, which includes reading (and potentially updating) the translation table, and 2) updating the translation state, which includes (but is not limited to) computing the next address to be referenced. Each step depends on the results from the previous step of the walk. For the first step, the address of the first translation table entry that is accessed is a function of the translation table base address and a portion of the input address to be translated. For each subsequent step, the address of the translation table entry accessed is a function of the translation table entry from the previous step and a portion of the input address.

A translation table walk is completed after a block descriptor is encountered and the final translation state is computed. If an invalid translation table descriptor is encountered, the walk has “faulted” and must be aborted or retried after the page table has been updated to replace the invalid translation table descriptor with a valid one (block or table descriptor). The combined information accrued from all previous steps of the translation table walk determines the final translation state of the “translation” and therefore influences the final result of the address translation (output address, access permissions, etc.).

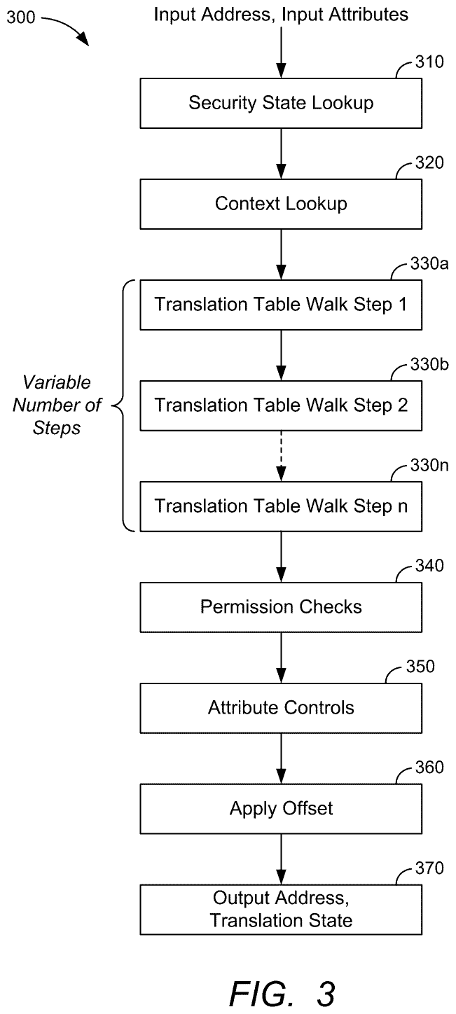

Address translation is the process of transforming an input address and set of attributes to an output address and attributes (derived from the final translation state). FIG. 3 is a diagram 300 illustrating the stages involved in address translation, according to aspects of the disclosure. The flow illustrated in FIG. 3 may be performed by an MMU (e.g., MMU 104) or an SMMU (e.g., SMMU 116 or 118), collectively, an MMU.

At stage 310, the MMU performs a security state lookup. An MMU is capable of being shared between secure and non-secure execution domains. The MMU determines to which domain an incoming transaction belongs based on properties of that transaction. Transactions associated with a secure state are capable of accessing both secure and non-secure resources. Transactions associated with a non-secure state are only allowed to access non-secure resources.

At stage 320, the MMU performs a context lookup. Each incoming transaction is associated with a “stream ID.” The MMU maps the “stream ID” to a context. The context determines how the MMU will process the transaction: 1) bypass address translation so that default transformations are applied to attributes, but no address translation occurs (i.e., translation tables are not consulted), 2) fault, whereby the software is typically notified of a fault, and the MMU terminates the transaction, such that it is not sent downstream to its intended target, or 3) perform translation, whereby translation tables are consulted to perform address translation and define attributes. Translation requires the resources of either one or two translation context banks (for single-stage and nested translation, respectively). A translation context bank defines the translation table(s) used for translation, default attributes, and permissions.

At stages 330a to 330n, the MMU performs a translation table walk. If a transaction requires translation, translation tables are consulted to determine the output address and attributes corresponding to the input address. If a transaction maps to a bypass context, translation is not required. Instead, default attributes are applied, and no address translation is performed.

At stage 340, the MMU performs a permissions check. The translation process defines permissions governing access to each region of memory translated. Permissions indicate which types of accesses are allowed for a given region (e.g., read/write), and whether an elevated permission level is required for access. When translation is complete, the defined permissions for the region of memory being accessed are compared against the attributes of the transaction. If the permissions allow the access associated with the transaction, the transaction is allowed to propagate downstream to its intended target. If the transaction does not have sufficient permissions, the MMU raises a fault and the transaction is not allowed to propagate downstream.

At stage 350, the MMU applies attribute controls. In addition to address translation, the MMU governs the attributes associated with each transaction. Attributes indicate such things as the type of memory being accessed (e.g., device, normal, etc.), whether or not the memory region is shareable, hints indicating if the memory region should be cached, etc. The MMU determines the attributes of outgoing transactions by combining/overriding information from several sources, such as 1) incoming attributes, whereby incoming attributes typically only affect output attributes when translation is bypassed, 2) statically programmed values in MMU registers, and/or 3) translation table entries.

At stage 360, the MMU applies an offset. Each translation table entry defines an output address mapping and attributes for a contiguous range of input addresses. A translation table can map various sizes of input address ranges. The output address indicated in a translation table entry is, therefore, the base output address of the range being mapped. To compute the final output address, the base output address is combined with an offset determined from the input address and the range size:

Output_address=base_output_address+(input_address mod range_size)

In other words, the N least significant bits of input and output addresses are identical, where N is determined by the size of the address range mapped by a given translation table entry.

At stage 370, the resulting translation state represents a completed translation. The completed translations can be stored in a translation cache to avoid having to perform all the steps of the translation table walk the next time an input address to the same block of memory is issued to the MMU.

At any stage (other than the last stage) of the translation table process illustrated in FIG. 3, the resulting translation state represents a partially completed translation. The partially completed translations can be stored in a translation cache to avoid having to perform all the same stages of the translation table walk the next time an input address to the same (or adjacent) block(s) of memory are issued to the MMU. Partially completed translations are completed by performing the remaining stages of the translation walk.

The translation cache, sometimes referred to as a translation look-aside buffer (TLB), is comprised of one or more translation cache entries. Translation caches store translation table information in one or more of the following forms: 1) fully completed translations, which contain all the information necessary to complete a translation, 2) partially completed translations, which contain only part of the information required to complete a translation such that the remaining information must be retrieved from the translation table or other translations caches, and/or 3) translation table data.

A translation cache assists in minimizing the average time required to translate subsequent addresses: 1) reduces the average number of accesses required to access the translation table during the translation process, and 2) keeps translations and/or translation table information in a fast storage device. A translation cache is usually quicker to access than the main memory store containing the translation/page tables. Specifically, referring to FIG. 3, instead of performing a translation table walk at stages 330, the MMU can perform a translation cache lookup to determine whether or not the requested address is already present in the translation cache. If it is, the MMU can skip the translation table walk at stages 330 and proceed to stage 340.

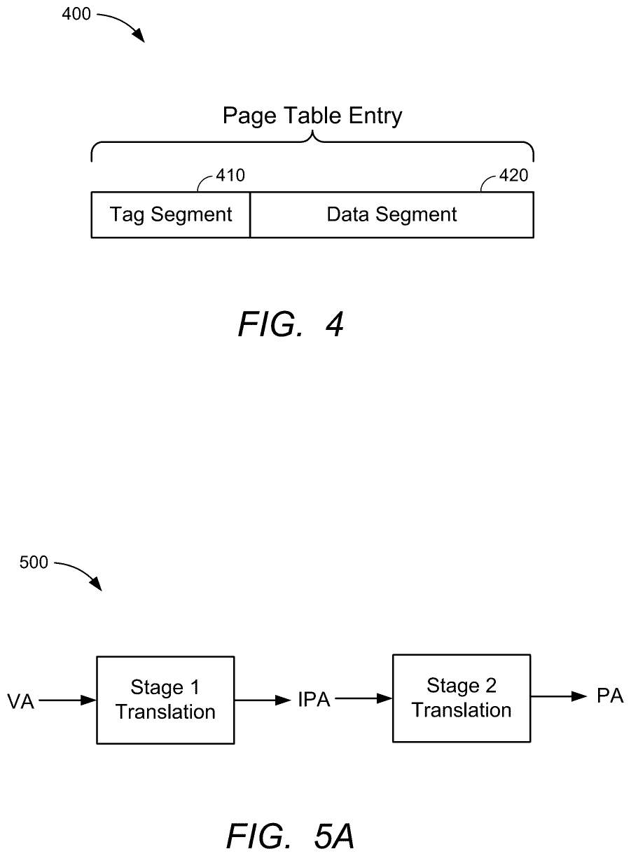

FIG. 4 illustrates an example TLB entry 400, according to aspects of the disclosure. A TLB entry 400 consists of a tag segment 410 and a data segment 420. The tag segment 410 comprises one or more fields that may be compared with a search comparand during a search (or lookup) of the translation cache. The tag may be derived from the virtual address (VA) and other relevant system information/context, such as security state, privilege level, virtual machine identifier (VMID), address space identifier (ASID), etc. The data segment 420 may include the PA, permissions, and other attributes associated with the translation. A full translation cache for completed translations includes one or more (e.g., N) TLB entries 400 and each TLB entry 400 holds information for one completed translation.

Second level address translation (SLAT), also referred to as “nested paging,” is a hardware-assisted virtualization technology that makes it possible to avoid the overhead associated with software-managed shadow page tables.

When a guest system uses virtual addresses and an instruction requests access to memory, the host processor translates the virtual memory address to a physical memory address using a page table or TLB. When running a virtual system, virtual memory of the host system serves as physical memory for the guest system. As such, to translate a virtual address (VA) (also referred to as a linear address (LA)) in the guest system to a physical address (PA) (also referred to as a host physical address (HPA)) in the host system, the address translation needs to be performed twice-once inside the guest system (translating from the VA to an intermediate physical address (IPA) (also referred to as a guest physical address (GPA)) using one or more virtual machine page tables), and once inside the host system (translating from the IPA to the PA using one or more hypervisor page tables). The former translation is referred to as a first stage translation, or a Stage-1 translation depending on the architecture (e.g., as in the ARM® architecture), and the latter translation is referred to as a second stage translation, or a Stage-2 translation depending on the architecture (e.g., as in the ARM® architecture).

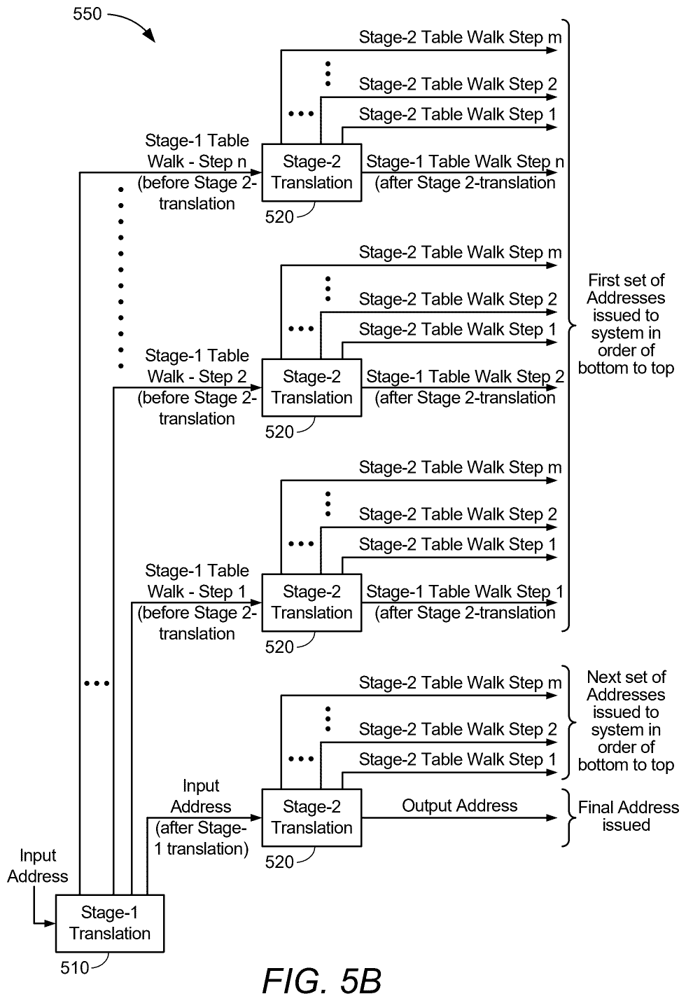

FIG. 5A is a block diagram 500 illustrating a two-stage translation from a virtual address (VA) to a physical address (PA), according to aspects of the disclosure. FIG. 5A shows the basic relationship between a VA, an IPA, and a PA. A VA is the input to the Stage-1 translation, which outputs an IPA. The IPA is the input to the Stage-2 (virtualized) translation, which outputs a PA.

FIG. 5B illustrates an example two-stage translation flow 550, according to aspects of the disclosure. In a two-stage translation, the MMU (e.g., MMU 104 in FIG. 1) receives a virtual input address (i.e., a VA) to be translated to an IPA by the Stage-1 Translation 510 using one or more virtual machine page tables, followed by the Stage-2 Translation 520 from the IPA to the corresponding one or more hypervisor page tables. A two-stage translation is sometimes referred to a “nested” translation because every reference from the Stage-1 translation process needs to undergo the Stage-2 translation process.

The Stage-1 translation 510 involves receiving a virtual input address (e.g., from a virtual machine or other guest system) and generating a Stage-1 output address (which is also the Stage-2 input address). A translation table walk (e.g., as illustrated in FIG. 2) of the Stage-1 translation table may be required during the process of the Stage-1 translation 510. Each step/access to the Stage-1 translation table needs to undergo Stage-2 translation 520.

The Stage-2 translation 520 involves receiving a Stage-2 input address (i.e., in IPA) and generating a Stage-2 output address (i.e., the PA). A translation table walk of the Stage-2 translation table may be required during the process of Stage-2 translation 520. Thus, as shown, address translation is performed twice, once inside the guest system (Stage-1), and once inside the host system (Stage-2).

A page table walk is a long-latency process because each entry in the tree needs to be read from memory, examined for faults, and used to find the next level entry. This latency is exacerbated by virtualized page tables, which exponentially increases the number of reads. Partial translation caches are used to skip a number of these reads, but these caches traditionally store either a virtual address (VA) to intermediate physical address (IPA) translation (e.g., a Stage-1 translation, as illustrated in FIGS. 5A and 5B) or an IPA to physical address (PA) translation (e.g., a Stage-2, or virtualized, translation, as illustrated in FIGS. 5A and 5B).

If the page table is virtualized (i.e., stores virtual addresses), a hit in a Stage-1 partial translation cache still needs to execute a Stage-2 translation, as described above with reference to FIGS. 5A and 5B. In an MMU (e.g., MMU 104), this would result in performing, at best, one additional page table entry read (in the case of a Stage-2 partial translation cache hit) and, at worst, four reads (in the case of a cache miss). These additional reads, and the associated latency and power costs of performing them, can be avoided by having a Stage-1 partial translation cache store a full VA to PA translation.

Note that a partial translation cache is a cache that stores the contents of all the page table entries accessed during a page walk prior to the leaf page table entry. The contents of the leaf page table entry are stored in a TLB.

To address the foregoing issues, the Stage-1 partial translation cache can store the full VA to PA translations of the non-leaf levels of the Stage-1 page table. In this case, when Stage-2 translation is enabled (as in the case of virtualized page tables), the MMU (e.g., MMU 104) can directly read a Stage-1 translation table entry instead of performing the Stage-2 page walk that would ordinarily be required to read the Stage-1 page table entry. This results in lower page walk latency and lower CPU power (specifically in the MMU by reducing the activity associated with transitioning from Stage-1 to Stage-2 and issuing page table entry reads and in the L2 cache by reducing the number of reads coming from the MMU).

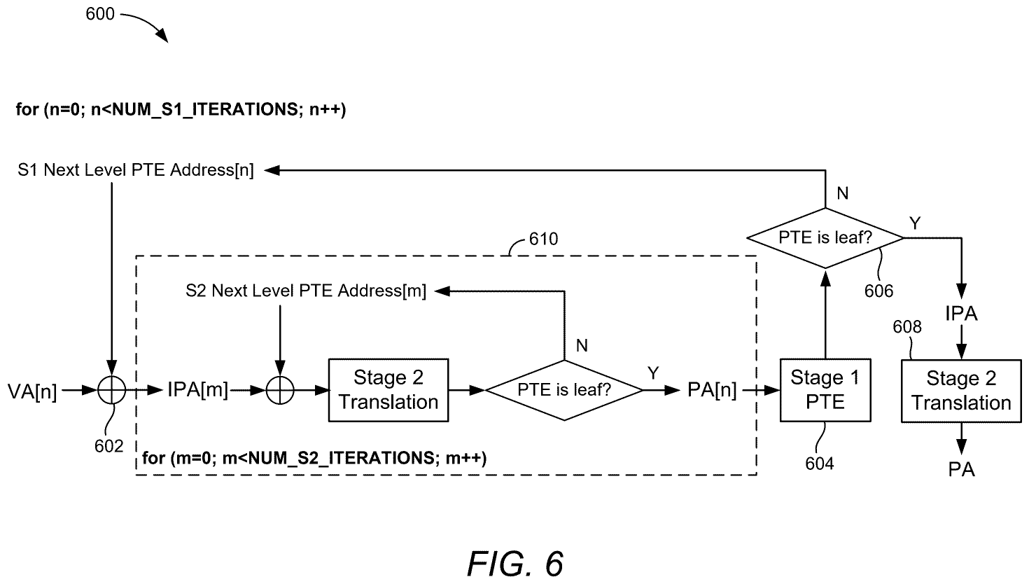

FIG. 6 is a diagram 600 illustrating an example logic flow of a page table walk, according to aspects of the disclosure. FIG. 6 illustrates the repetition and nesting of the basic process illustrated in FIG. 5A. At a high level, the MMU (e.g., MMU 104) fetches the Stage-1 (S1) PTE using a PA. The next-level address in the Stage-1 PTE (denoted “S1 Next Level PTE Address[n]”) is an IPA, so the MMU performs the Stage-2 (S2) translation repeatedly until the end is reached.

In greater detail, to find the next PTE, bits of the input address (denoted “VA[n]”) are concatenated with the “next-level table address” by combiner 602. This next-level address (denoted “S1 Next Level PTE Address[n]”) is either: (1) at the start of the walk, the base address, or (2) after the first PTE has been read, the address in the PTE that was just read. The PA inside the PTE that was just fetched does not directly point to the next PTE. The bits of the IPA for that level are concatenated with the PA in order to fetch the next PTE.

The “PTE is leaf?” block 606 and “Stage 2 Translation” block 608 are outside the dashed box 610 because the flow of the page walk is different after the leaf entry is reached. There is a loop for the Stage 1 translation and a loop for the Stage 2 translation to represent the parts that truly are iterative. If the PTE is the leaf, the loop is broken. In the case of Stage 2, there is a PA that points to the Stage 1 PTE, so the Stage 2 loop is broken and the Stage 1 loop is re-entered. Alternatively, in the case of Stage 1, if a leaf is reached, the loop is broken and a final Stage 2 translation is performed, but this Stage 2 translation does not behave the same way as the others. That is, in this case, bits from the VA and an IPA are not concatenated to create the input address; instead, the IPA is taken from the PTE and translated directly. This is why block 604 is different from the elements inside the dashed box 610; the input to block 604 is different than the input to the dashed box 610.

Using the illustrated logic, if a first stage translation (from VA to IPA, denoted “Stage-1”) partial translation cache hits at level 3, for example, of the partial translation cache, a conventional two-stage page table walk would produce an IPA that needs to be translated through the second stage translation (from IPA to PA, denoted “Stage-2”) one time before the first stage level 3 page table entry (PTE) can be fetched, as shown within the dashed box 610. With the first stage partial translation cache disclosed herein, that second stage translation is skipped because the disclosed translation cache produces a PA and directly fetches the first stage level 3 PTE. That is, the logic within box 610 is skipped when there is a hit in the first stage partial translation cache, and VA[n] is passed directly to the first stage PTE block.

Note that although not illustrated, there is one more step of the Stage-2 translation after the Stage-1 leaf in which the IPA is not combined with any bits from the input address and is simply translated as-is.

The number of iterations is determined by the translation configuration. Specifically, NUM_S1_ITERATIONS=((VA_SIZE−VA_LSB)/STRIDE)+1, where VA_SIZE is the size of the virtual address, VA_LSB is the number of least significant bits (LSBs) of the virtual address, and STRIDE is the size of the stride. As an example, for 4 kilobyte (KB) paging, if STRIDE=9 and VA_LSB=12, then a 48-byte virtual address results in n=((48-12)/9)+1=5.

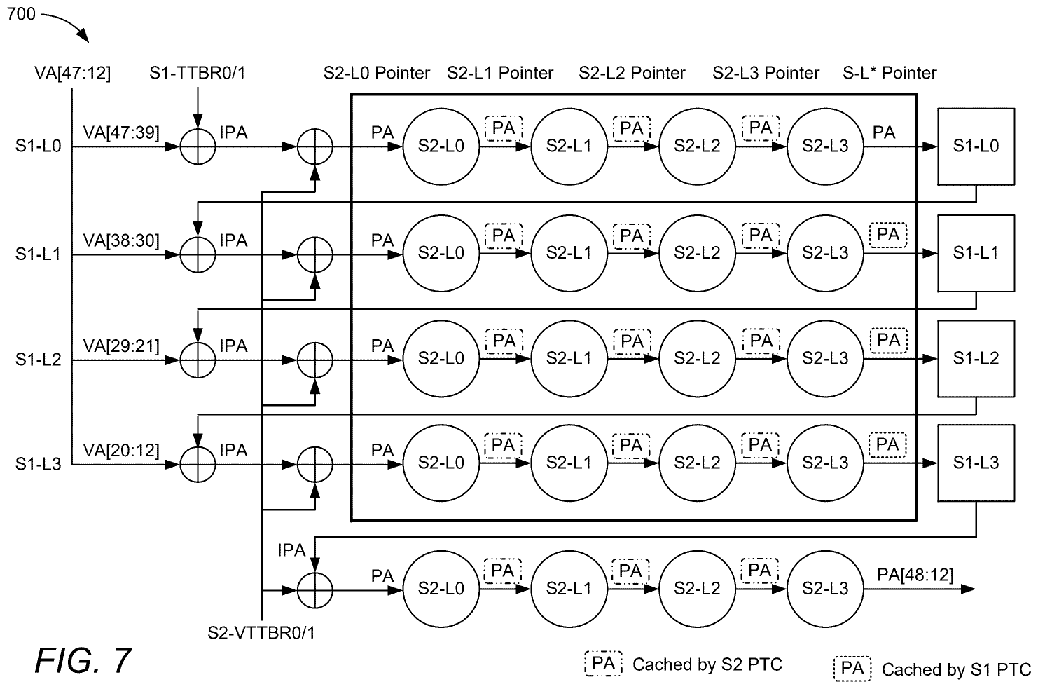

FIG. 7 is a diagram 700 illustrating a fully virtualized page table walk of a Stage-1 partial translation cache that stores the full VA to PA translations of the non-leaf levels of the page table, according to aspects of the disclosure. The example page table has four levels, denoted “L0,” “L1,” “L2,” and “L3.” The square boxes on the right of the figure represent the Stage-1 (S1) page table entries (which store IPAs) at each level of the page table and the circles represent the Stage-2 (S2) page table entries at each level of the page table. That is, the circles and squares represent reads of page table entries from memory.

The dashed boxes around certain physical addresses (PAs) indicate that the respective PAs are either cached in the Stage-1 partial translation cache (PTC) or the Stage-2 partial translation cache, depending on the dash type. The heavy black box represents the operations within the partial translation cache.

In the example of FIG. 7, the virtual address (VA) used to address the page table entries is [47:12] bits. The first level (i.e., L0) of the partial translation cache corresponds to bits [47:39], the second level (i.e., L1) of the cache corresponds to bits [38:30], the third level (i.e., L2) of the cache corresponds to bits [29:21], and the fourth level (i.e., L3) of the cache corresponds to bits [20:12].

In the event of a cache read, first, bits [47:39] of the incoming VA are concatenated to a Stage-1 base address (denoted “S1-TTBR0/1”) configured by the host system, resulting in an IPA. The IPA is then concatenated with a Stage-2 base address (denoted “S2-VTTBR0/1”), resulting in a PA. The PA is then used to walk through the Stage-2 page table entries for each Stage-2 level (denoted “S2-L0,” “S2-L1,” “S2-L2,” and “S2-L3”) to determine whether there is a hit on the PA in the first Stage-1 level of the partial translation cache (which corresponds to bits [47:39] of the VA). That is, within the Stage-1 partial translation cache (as illustrated in FIG. 7), at each Stage-1 level, there are page table entries for each Stage-2 level (here, four levels) corresponding to the Stage-1 level bits of the address. Thus, in the event of a first level (i.e., L0) Stage-1 partial translation cache hit, the output is the PA for the second level (i.e., L1) Stage-1 page table entry (i.e., represented by the square labeled “S1-L1”), and the page table walks for the Stage-2 page table entries for the VA bits [38:30], [29:21], and [20:12] (represented by the corresponding three rows of circles) can be skipped. That is, when the L0 range of the VA is matched, conventionally, the contents of the S1-L0 PTE are obtained, which is an IPA. The innovation of the disclosed technique is that the translation of that IPA is stored, which points to the S1-L1 PTE.

In the event of a miss at the first Stage-1 level (i.e., S1-L0), bits [38:30] of the VA are concatenated with the S1-L0 IPA, and the resulting IPA is concatenated with the Stage-2 base address (denoted “S2-VTTBR0/1”), resulting in a second PA. The second PA is then used to walk through the Stage-2 page table entries for each Stage-2 level, as above. Here, for a second level (i.e., L1) Stage-1 partial translation cache hit, the output is the PA for the third level (i.e., L2) Stage-1 page table entry (i.e., represented by the square labeled “S1-L2”), and the page table walks for the Stage-2 page table entries for the VA bits [29:21] and [20:12] (represented by the corresponding two rows of circles) can be skipped.

In the event of a miss at the second Stage-1 level (i.e., S1-L1), bits [29:21] of the VA are concatenated with the S1-L1 IPA, and the resulting IPA is concatenated with the Stage-2 base address (denoted “S2-VTTBR0/1”), resulting in a third PA. The third PA is then used to walk through the Stage-2 page table entries for each Stage-2 level, as above. Here, for a third level (i.e., L2) Stage-1 partial translation cache hit, the output is the PA for the fourth level (i.e., L3) Stage-1 page table entry (i.e., represented by the square labeled “S1-L3”), and the page table walks for the Stage-2 page table entries for the VA bits VA[20:12] (represented by the corresponding row of circles) can be skipped.

The bottom row of FIG. 7 represents the final stage of the page table walk. The physical address PA[48:12] represents the final address translation (the leaf page table entry), which is stored in the TLB.

Thus, the Stage-1 partial translation cache stores the results of Stage-2 translations (i.e., PAs) for each level of the Stage-1 translation. As shown, these Stage-2 PA page table entries are obtained by concatenating the respective bits of the VA (e.g., [38:30]) with the Stage-1 base address (denoted “S1-TTBR0/1”), and then concatenating the resulting IPA with the Stage-2 base address (denoted “S2-VTTBR0/1”) to obtain the Stage-2 PA. In this way, the translation necessary at stage 520 of FIG. 5B is eliminated. Note that in this architecture, there is not a Stage-1 partial translation table and a Stage-2 partial translation table, but rather, a single stage partial translation table.

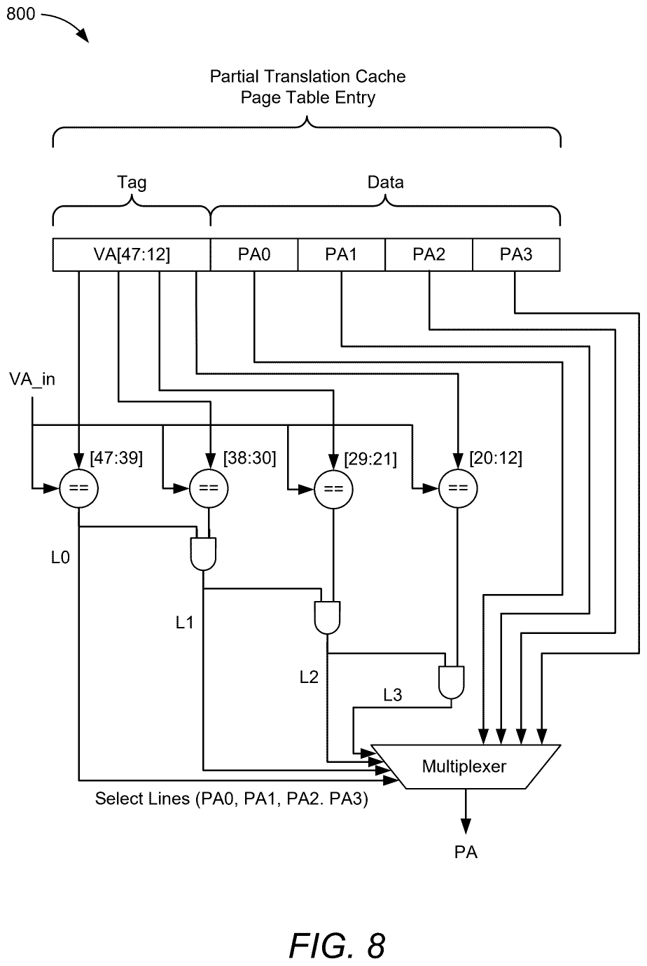

FIG. 8 is a diagram 800 illustrating an example logic flow within a partial translation cache, according to aspects of the disclosure. As shown in FIG. 8, a page table entry for the partial translation cache includes a tag segment (e.g., tag segment 410) and a data segment (e.g., data segment 420). In the example of FIG. 8, the tag segment includes a virtual address (bits [47: 12]) and the data segment includes, for example, four physical addresses (denoted “PA0,” “PA1,” “PA2,” and “PA3”). The four physical addresses correspond to the four Stage-2 levels. As will be appreciated, however, there may be more or fewer than four physical addresses per virtual address.

As shown in FIG. 8, bits [47:39], [38:30], [29:21], and [20:12] of an input virtual address (denoted “VA_in”) are compared (by an “==” operator) to bits [47:39], [38:30], [29:21], and [20:12] of the virtual address stored in the page table entry. If there is a match (e.g., an output of “1”) of bits [47:39], the result is used to select a first physical address in the data segment (e.g., PA0). If there is a match of bits [47:39] and [38:30], the result is used to select a second physical address in the data segment (e.g., PA1). If there is a match of bits [47: 39], [38:30], and [29:21], the result is used to select a third physical address in the data segment (e.g., PA2). If there is a match of bits [47:39], [38:30], [29:21], and [20:12], the result is used to select a fourth physical address in the data segment (e.g., PA3). If none of the bits match, there is a miss in the partial translation cache.

Note that the specific bit numbers in FIGS. 7 and 8 are merely examples, and the disclosure is not limited to these examples. FIGS. 7 and 8 show 4KB-aligned addresses but the disclosure covers a plurality of address alignments/translation granules.

Further note that the disclosed Stage-1 partial translation cache may also store VA-to-PA translations for CPU modes where Stage-2 translation is not supported. That is, the disclosed structure does not specifically serve only modes where both Stage-1 and Stage-2 are enabled.

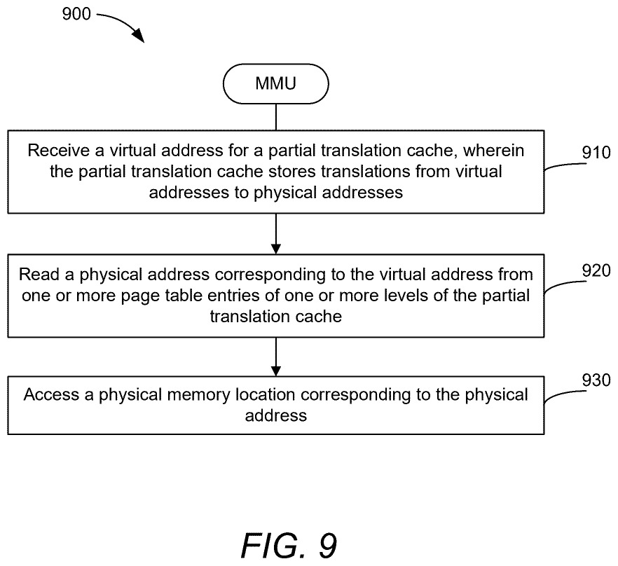

FIG. 9 illustrates an example method 900 for operating an MMU, according to aspects of the disclosure. The method 900 may be performed by MMU 104, for example.

At operation 910, the MMU receives a virtual address for a partial translation cache (e.g., one of translation tables 122), wherein the partial translation cache stores translations from virtual addresses to physical addresses.

At operation 920, the MMU reads a physical address corresponding to the virtual address from one or more page table entries (e.g., TLB entry 400) of one or more levels (e.g., L0, L1, L2, L3 in FIGS. 7 and 8) of the partial translation cache.

At operation 930, the MMU accesses a physical memory location (e.g., of memory 106) corresponding to the physical address.

In some aspects, the partial translation cache stores virtual address to physical address translations of all non-leaf levels of a physical address page table.

In some aspects, method 900 further includes (not shown) converting the virtual address to an intermediate physical address within the partial translation cache; and converting the intermediate physical address to the physical address within the partial translation cache.

In some aspects, reading the physical address at operation 920 includes reading a first set of bits of the virtual address; converting the first set of bits of the virtual address to a first portion of the physical address; and determining whether the first portion of the physical address matches a first page table entry of a first level of the partial translation cache.

In some aspects, reading the physical address at operation 920 includes determining that the first portion of the physical address matches the first page table entry in the first level of the partial translation cache; and reading the physical address from the first page table entry of the first level of the partial translation cache.

In some aspects, reading the physical address at operation 920 includes determining that the first portion of the physical address does not match the first page table entry of the first level of the partial translation cache; reading a second set of bits of the virtual address; converting the second set of bits of the virtual address to a second portion of the physical address; and determining whether the second portion of the physical address matches a second page table entry of a second level of the partial translation cache.

In some aspects, reading the physical address at operation 920 includes determining that the second portion of the physical address matches the second page table entry of the second level of the partial translation cache; and reading the physical address from the second page table entry of the second level of the partial translation cache.

In some aspects, reading the physical address at operation 920 includes determining that the second portion of the physical address does not match the second page table entry of the second level of the partial translation cache; reading a third set of bits of the virtual address; converting the third set of bits of the virtual address to a third portion of the physical address; and determining whether the third portion of the physical address matches a third page table entry of a third level of the partial translation cache.

In some aspects, reading the physical address at operation 920 includes determining that the third portion of the physical address matches the third page table entry of the third level of the partial translation cache; and reading the physical address from the third page table entry of the third level of the partial translation cache.

In some aspects, the virtual address is associated with a guest system, and the physical address is associated with a host system.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

1. A method of operating a memory management unit (MMU), comprising:
receiving a virtual address for a partial translation cache, wherein the partial translation cache stores virtual address to physical address translations of all non-leaf levels of a physical address page table;
reading a physical address corresponding to the virtual address from one or more page table entries of one or more levels of the partial translation cache; and
accessing a physical memory location corresponding to the physical address.

2. (canceled)

3. The method of claim 1, further comprising:
converting the virtual address to an intermediate physical address within the partial translation cache; and
converting the intermediate physical address to the physical address within the partial translation cache.

4. The method of claim 1, wherein reading the physical address comprises:
reading a first set of bits of the virtual address;
converting the first set of bits of the virtual address to a first portion of the physical address; and
determining whether the first portion of the physical address matches a first page table entry of a first level of the partial translation cache.

5. The method of claim 4, wherein reading the physical address comprises:
determining that the first portion of the physical address matches the first page table entry in the first level of the partial translation cache; and
reading the physical address from the first page table entry of the first level of the partial translation cache.

6. The method of claim 4, wherein reading the physical address comprises:
determining that the first portion of the physical address does not match the first page table entry of the first level of the partial translation cache;
reading a second set of bits of the virtual address;
converting the second set of bits of the virtual address to a second portion of the physical address; and
determining whether the second portion of the physical address matches a second page table entry of a second level of the partial translation cache.

7. The method of claim 6, wherein reading the physical address comprises:
determining that the second portion of the physical address matches the second page table entry of the second level of the partial translation cache; and
reading the physical address from the second page table entry of the second level of the partial translation cache.

8. The method of claim 6, wherein reading the physical address comprises:
determining that the second portion of the physical address does not match the second page table entry of the second level of the partial translation cache;
reading a third set of bits of the virtual address;
converting the third set of bits of the virtual address to a third portion of the physical address; and
determining whether the third portion of the physical address matches a third page table entry of a third level of the partial translation cache.

9. The method of claim 8, wherein reading the physical address comprises:
determining that the third portion of the physical address matches the third page table entry of the third level of the partial translation cache; and
reading the physical address from the third page table entry of the third level of the partial translation cache.

10. The method of claim 1, wherein:
the virtual address is associated with a guest system, and
the physical address is associated with a host system.

11. An apparatus, comprising:
one or more memories; and
one or more processors; and
a memory management unit (MMU) coupled to the one or more processors and the one or more memories, the MMU configured to:
receive a virtual address for a partial translation cache, wherein the partial translation cache stores virtual address to physical address translations of all non-leaf levels of a physical address page table;
read a physical address corresponding to the virtual address from one or more page table entries of one or more levels of the partial translation cache; and
access a physical memory location in the one or more memories corresponding to the physical address.

12. (canceled)

13. The apparatus of claim 11, wherein the MMU is further configured to:
convert the virtual address to an intermediate physical address within the partial translation cache; and
convert the intermediate physical address to the physical address within the partial translation cache.

14. The apparatus of claim 11, wherein the MMU configured to read the physical address comprises the MMU configured to:
read a first set of bits of the virtual address;
convert the first set of bits of the virtual address to a first portion of the physical address; and
determine whether the first portion of the physical address matches a first page table entry of a first level of the partial translation cache.

15. The apparatus of claim 14, wherein the MMU configured to read the physical address comprises the MMU configured to:
determine that the first portion of the physical address matches the first page table entry in the first level of the partial translation cache; and
read the physical address from the first page table entry of the first level of the partial translation cache.

16. The apparatus of claim 14, wherein the MMU configured to read the physical address comprises the MMU configured to:
determine that the first portion of the physical address does not match the first page table entry in the first level of the partial translation cache;
read a second set of bits of the virtual address;
convert the second set of bits of the virtual address to a second portion of the physical address; and
determine whether the second portion of the physical address matches a second page table entry of a second level of the partial translation cache.

17. The apparatus of claim 16, wherein the MMU configured to read the physical address comprises the MMU configured to:
determine that the second portion of the physical address matches the second page table entry of the second level of the partial translation cache; and
read the physical address from the second page table entry of the second level of the partial translation cache.

18. The apparatus of claim 16, wherein the MMU configured to read the physical address comprises the MMU configured to:
determine that the second portion of the physical address does not match the second page table entry of the second level of the partial translation cache;
read a third set of bits of the virtual address;
convert the third set of bits of the virtual address to a third portion of the physical address; and
determine whether the third portion of the physical address matches a third page table entry of a third level of the partial translation cache.

19. The apparatus of claim 18, wherein the MMU configured to read the physical address comprises the MMU configured to:
determine that the third portion of the physical address matches the third page table entry of the third level of the partial translation cache; and
read the physical address from the third page table entry of the third level of the partial translation cache.

20. The apparatus of claim 11, wherein:
the virtual address is associated with a guest system, and
the physical address is associated with a host system.
